(19) United States
(12) Patent Application Publication
(10) Pub. No.: US 2026/0238997 A1
(43) Pub. Date: Aug. 13, 2026

(54) LOCAL INITIALIZATION VECTOR GENERATION USING A PARTIAL ENTROPY SEED FOR ENCRYPTION OF SDWAN OVERLAY

(71) Applicant: Versa Networks, Inc., Santa Clara, CA (US)

(72) Inventor: Jayakrishnan Iyer, Morgan Hill, CA (US)

(21) Appl. No.: 19/052,717

(22) Filed: Feb. 13, 2025

(51) Int. Cl. H04W 12/037; H04L 9/32

(52) U.S. Cl. CPC H04W 12/037; H04L 9/32

(57) ABSTRACT

Local initialization vector (IV) generation using a partial entropy seed is described. In one example a method includes, generating a first IV using a first generation first partial entropy seed and a first generation second partial entropy seed, encrypting a first packet using the first IV, sending the first packet through a secure tunnel of a software-defined wide area network (SDWAN), sending a second generation first partial entropy seed, receiving an acknowledgment of the second generation first partial entropy seed, generating a second IV at the first hub based on the second generation first partial entropy seed and the first generation second partial entropy seed, encrypting a second packet using the second IV, and sending the second packet from the first hub to the second hub through the secure tunnel.

### TECHNICAL FIELD

The present description relates to the initialization vector for software-defined wide area network overlays and, in particular to local initialization vector generation.

### BACKGROUND

A software-defined wide area network (SDWAN) overlay environment allows hubs, such as edge nodes to route packets to other edge nodes through a wide area network. The overlay environment is built on top of an existing network infrastructure whether a public infrastructure like the Internet or a private network. The hubs encapsulate one or more data packets in a wrapper, or outer packet, to send packets through a virtual tunnel created in the public or private network. The wrapper has an outer packet header to ensure that the encapsulated packet reaches the intended destination hub.

Network data communications may rely on virtualized resources to carry the data in an SDWAN. A VNF (Virtual Network Function) may take the place of a hardware router. An SDWAN may take the place of dedicated physical network resources. An SDWAN may be configured to connect one or more end nodes, clients, and local area networks (LANs) to a branch. One or more branches are coupled to a hub. The hubs are able to act as gateways to a plurality of branches. The branches may also serve as edge nodes or hubs through direct access to the Internet through one or more wide area network (WAN) links or may have access through other nodes to gain access through other edge nodes or hubs.

A network appliance (NA) may be physical or virtualized, for example as a virtualized network function (VNF) and used to process packets using each packet's 4-tuple or 5-tuple. A typical 5-tuple is a packet header that includes a source internet protocol address (src-ip), a destination internet protocol address (dst-ip), a protocol (proto), a source port (src-port) and a destination port (dst-port) and may be designated using the notation <src-ip, dst-ip, proto, src-port, dst-port>. Using this information, an NA is able to perform service plane processing including Network Address Translation (NAT), Next Gen Fire Wall (NGFW), and Unified Threat Management (UTM).

The SDWAN overlay environment features technologies to provide secure connectivity between multiple hubs over discrete underlay network transports such as Multi-Protocol Label Switching (MPLS), broadband, Long Term Evolution (LTE), satellite links etc. A full-fledged SDWAN offers features such as traffic steering, inline accurate loss measurement, Forward Error Correction (FEC) etc. In addition, the SDWAN may offer security features e.g. Internet Protocol Security/Datagram Transport Layer Security (IPSec/DTLS),

In the context of IPsec usage within an SDWAN overlay, an Initialization Vector (IV) is often used as an input parameter for symmetric encryption algorithms, e.g., Cipher Block Chaining (CBC). The IV is used to initialize the encryption and decryption process so that even the same data block encrypted with the same key will result in a different ciphertext. The IV is used to enhance security by ensuring uniqueness and preventing repeating patterns that can be exploited by Man-In-The-Middle (MITM) attacks. The IV has a fixed size, e.g. 8 or 16 octets, and is sent with each packet in the header of the outer packet, also referred to as the SDWAN header of the wrapper.

### SUMMARY

Embodiments herein relate to a method that includes generating a first initialization vector using a first generation first partial entropy seed and a first generation second partial entropy seed, encrypting a first packet using the first initialization vector, sending the first packet from a first hub to a second hub through a secure tunnel of a software-defined wide area network (SDWAN), sending a second generation first partial entropy seed from the first hub to the second hub, receiving an acknowledgment of the second generation first partial entropy seed from the second hub at the first hub, generating a second initialization vector at the first hub based on the second generation first partial entropy seed and the first generation second partial entropy seed, encrypting a second packet using the second initialization vector, and sending the second packet from the first hub to the second hub through the secure tunnel.

In some embodiments sending the first packet comprises sending the first packet through a data plane and wherein sending the second generation first partial entropy seed comprises sending the second generation first partial entropy seed through a control plane.

In some embodiments sending the first partial entropy seed comprises sending the first partial entropy seed through a controller of the SDWAN.

Some embodiments include encrypting subsequent packets using the first initialization vector and sending the subsequent packets through the secure tunnel until after receiving the acknowledgment.

Some embodiments include receiving a second generation second partial entropy seed from the second hub at the first hub, sending an acknowledgment of the second generation second partial entropy seed to the second hub from the first hub, generating a third initialization vector at the first hub based on the second generation first partial entropy seed and the second generation second partial entropy seed, encrypting a third packet using the third initialization vector, and sending the third packet from the first hub to the second hub through the secure tunnel.

In some embodiments sending the first partial entropy seed comprises sending entropy seed parameters. In some embodiments sending the entropy seed parameters comprises sending encryption entropy bytes and an encryption entropy length and decryption entropy bytes and a decryption entropy length for decryption. In some embodiments sending the entropy seed parameters further comprises sending nonce bytes and a nonce length.

In some embodiments sending the first partial entropy seed comprises sending a generation number to indicate a generation of the first partial entropy seed of the first hub and the second hub, the method further comprising receiving a generation of the first partial entropy seed from the second hub. In some embodiments the generation from the second hub indicates an initialization vector used for decryption by the second hub. In some embodiments generating the initialization vector comprises generating the initialization vector based on the first partial entropy seed having the generation received from the second hub.

In some embodiments sending the first partial entropy seed comprises sending the first partial entropy seed using a border gateway protocol. In some embodiments using the border gateway protocol comprises sending a type, length, value protocol data unit within the border gateway protocol. In some embodiments sending the entropy seed parameters comprises sending the entropy seed parameters in an out-of-band message.

In some embodiments encapsulating the encrypted packet comprises generating the outer packet header without the initialization vector.

In some embodiments the outer packet header includes an encapsulating security payload without the initialization vector.

Some embodiments include exchanging capabilities with the second hub before sending the first partial entropy seed to determine that the second hub supports generating the initialization vector based on the entropy seed.

Some embodiments herein relate to a network node that includes a processor; and a storage medium having instructions stored thereon to cause the network node to perform operations that include generating a first initialization vector using a first generation first partial entropy seed and a first generation second partial entropy seed, encrypting a first packet using the first initialization vector, sending the first packet from a first hub to a second hub through a secure tunnel of a software-defined wide area network (SDWAN), sending a second generation first partial entropy seed from the first hub to the second hub, receiving an acknowledgment of the second generation first partial entropy seed from the second hub at the first hub, generating a second initialization vector at the first hub based on the second generation first partial entropy seed and the first generation second partial entropy seed, encrypting a second packet using the second initialization vector, and sending the second packet from the first hub to the second hub through the secure tunnel.

Some embodiments herein relate to a network node that includes a session management module configured to facilitate a secure tunnel of a software-defined wide area network (SDWAN) between a first hub and a second hub, a processor configured to generate a first initialization vector using a first generation first partial entropy seed and a first generation second partial entropy seed and to encrypt a first packet using the first initialization vector; and a communications interface configured to send the first packet from the first hub to the second hub through a secure tunnel, to send a second generation first partial entropy seed from the first hub to the second hub, and to receive an acknowledgment of the second generation first partial entropy seed from the second hub at the first hub, the processor further configured to generate a second initialization vector at the first hub based on the second generation first partial entropy seed and the first generation second partial entropy seed and to encrypt a second packet using the second initialization vector, the communications interface further configured to send the second packet from the first hub to the second hub through the secure tunnel.

In some embodiments the communications interface is to send the first partial entropy seed through a controller of the SDWAN.

### BRIEF DESCRIPTION OF THE FIGURES

The embodiments herein will be better understood from the following detailed description with reference to the drawing figures, in which:

FIG. 1 is a simplified diagram of a wired or wireless network in which clients communicate through an SDWAN suitable for embodiments herein;

FIG. 2 is a diagram of an example of a portion of an outer packet header that may be used in a secure tunnel, e.g., in an SDWAN overlay environment, suitable for embodiments herein;

FIG. 3 is a message sequence diagram of establishing an SDWAN overlay and capabilities for local generation of an Initialization Vector (IV) through a controller using a control plane suitable for embodiments herein;

FIG. 4 is a message sequence diagram of propagating entropy seeds in an SDWAN overlay with Border Gateway Protocol (BGP) suitable for embodiments herein;

FIG. 5 is a process flow diagram of routing traffic from a first hub to a second hub through an SDWAN with a reduced outer packet header suitable for embodiments herein;

FIG. 6 is a process flow diagram from the perspective of a single hub of routing traffic from a first hub to a second hub through an SDWAN with a reduced outer packet header suitable for embodiments herein;

FIG. 7 is a process flow diagram of entropy reseeding from a first hub to a second hub through an SDWAN suitable for embodiments herein;

FIG. 8 is a message sequence diagram of establishing an initialization vector using entropy seeds sent through a controller in an SDWAN overlay suitable for embodiments herein;

FIG. 9 is a message sequence diagram of re-seeding a first entropy seed of an initialization vector through a controller an SDWAN overlay suitable for embodiments herein;

FIG. 10 is a message sequence diagram of re-seeding a second entropy seed of an initialization vector through a controller in an SDWAN overlay suitable for embodiments herein; and

FIG. 11 is a block diagram of a network node, such as a hub, branch, or client suitable for embodiments herein.

### DETAILED DESCRIPTION OF EMBODIMENTS

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

The Initialization Vector (IV) has widespread use for SDWAN security. When used, the IV affects the output of the Galois Message Authentication (GMAC) or Galois Counter Mode (GCM). Transforms of the Advanced Encryption Standard (AES), e.g., AES-GCM, use the IV to generate nonces for encryption and decryption. Cipher Block Chaining Message Authentication Code mode also uses the IV. With a typical IV having 8 or 16 octets transmitted in the clear as part of the Internet Protocol (IP) Encapsulating Security Payload (ESP) data, the IV consumes a significant part of the ESP and may present a security risk because it is transmitted in the clear with the rest of the ESP header.

The ESP is typically transmitted as a part of the outer packet header. All of the ESP header is overhead that may affect the size of the payload or the rate at which packets may be sent. Removing 8 or 16 octets from the outer packet header of every packet can be a significant reduction in overhead. As described herein, the IV transmission may be avoided completely. Instead, an entropy seed may be communicated in the control plane of the overlay environment. Each hub may then use the seed to locally generate the same IV.

Upon facilitating a secure tunnel of the SDWAN with a second hub, a hub may provide for the local generation of the IV by both hubs. The hub sends an entropy seed to the second hub through the control plane. The entropy seed, described in more detail below, may allow the second hub to generate the IV locally instead of receiving it with each packet. The first hub generates the IV based on the entropy seed and then uses the locally generated IV to encrypt the packet using the initialization vector. The encrypted packet is sent to the second hub through the secure tunnel in an outer packet header that does not include the IV. The second hub may then use its own locally generated IV to decrypt the packet and forward it to the destination. Generating the IV locally reduces the overhead for packets traversing the secure tunnel. This is particularly useful when the data bandwidth is limited through the tunnel. In modern devices with spare computing capability the entropy seeds and the IV may easily be generated for each peer-tenant (<peer, tenant>) combination.

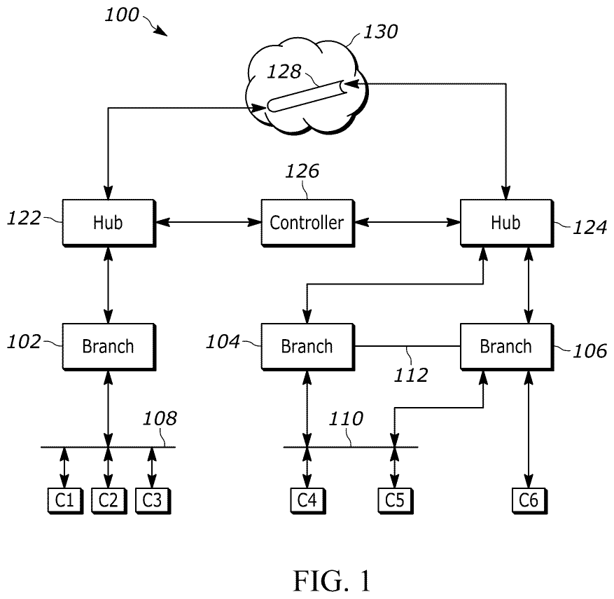

FIG. 1 is a simplified diagram of a wired or wireless network 100, or a hybrid of wired and wireless networks, in which multiple nodes, for example routers, have redundant paths between multiple clients and the cloud or the Internet. A first branch 102 is an active node or VNF that is coupled to a first local area network (LAN) 108 with one or more clients C1, C2, C3, end nodes or other nodes. A second branch 104 is another active node that is coupled to a second LAN 110 with one or more clients C4, C5 that may be end nodes or intermediate nodes of any suitable type. A third branch 106 is coupled to another end node C6 using any suitable connection. The first branch 102 is separated from the second branch 104 and the third branch 106.

The second branch 104 and the third branch 106 may be connected through a link 112 of any suitable type, e.g. Border Gateway Protocol (BGP), Virtual Router Redundancy Protocol (VRRP), or a network protocol, such as Ethernet, Wi-Fi, etc. Each of the branches may be coupled to other nodes of other networks, through any suitable protocol and medium, e.g., Access Routers (AR), Provider Edge (PE) nodes, Base Stations, interfaces to other private and public Wide Area Networks (WAN), and other branches.

The first branch 102 is coupled through a suitable network connection to a first hub 122. Alternatively, the first branch 102 includes the first hub 122. The second branch 104 and the third branch 106 are coupled to a second hub 124. The third branch 106 may be coupled through the second branch 104 or one or both of the branches may include a hub. The particular ordering and number of nodes is provided as an example. There may be many more end nodes, branches, and hubs. In this example, the first hub 122 is not directly connected to the second hub 124 but is coupled indirectly through a secure tunnel 128 through a WAN 130. The WAN 130 may be a single network or a combination of different networks with the same or different physical and protocol layers, e.g. the Internet. A controller 126 is coupled through a control plane to each hub. While one controller 126 is shown, there may be multiple controllers coupled to each other. In this architecture, the first hub 122 and the second hub 124 are operated as edge nodes or gateway nodes on each respective side of the WAN 130. A hub may be a router, or it may be another device that receives data traffic and sends the data traffic to another node. As such, “hubs” and “nodes” are intended to include “routers” and also a variety of other physical or virtual devices to which the techniques and structures herein may apply. The particular architecture is provided only as examples of nodes and connections and the principles described herein may be applied to many different configuration and architectures with more or fewer nodes in different combinations.

The secure tunnel 128 through the WAN 130 is referred to herein as the data plane and carries in-band (IB) communications using a secure tunnel through encapsulating data packets within a wrapper. The secure tunnel may also carry OOB communications through the data plane. The connection of the controller 126 to the first hub 122 and the second hub 124 is a control path referred to herein as the control plane and carries out-of-band (OOB) communications using point-to-point secure communications. The control path may also be through the WAN 130 using a different secure tunnel.

The data plane is operated through the WAN 130, which may not be secure. Accordingly, security is maintained by establishing the secure tunnel 128 and encrypting each packet before it is sent through the tunnel. Each packet has a wrapper with an outer header in clear text. The outer header has routing information, e.g., a 4-tuple or 5-tuple, that facilitates the packet being sent from the first hub 122 to the second hub 124.

In an IPSec protocol and other protocols, the Initialization Vector (IV) is a value in a field of the outer packet header with a fixed size, e.g., 8 or 16 octets. It is used by the sending hub as an input parameter for encryption. It is used by the receiving hub as an input for decryption. The IV is generated at the transmitting branch using an entropy seed, received from the controller 126 through the control plane. In another example, the controller 126 generates the IV and sends it to the transmitting branch. In some systems, the IV is then XORed with the plaintext before encryption, especially in streaming modes like Cipher Block Chaining (CBC). The IV is transmitted in the clear as part of the IP Encapsulating Security Payload (ESP) data of the outer packet header. While the IV is not part of the additional authenticated data (AAD), it does affect the output of the GMAC (or GCM) mode. Transforms like AES-GCM and AES-CCM use the IV to generate nonces for encryption and decryption. Transmitting the IV in the clear allows the recipient, the receiving branch, to perform the same XOR operation during decryption to recover the plaintext.

In an IPSec protocol, the IV is unique for each packet transmission. This ensures that identical plaintext blocks do not produce the same ciphertext. Changing the IV results in different authentication tags, providing some level of authentication. This technique prevents an attacker from deducing that identical blocks are being sent, enhancing security. Changing the IV helps to ensure enough entropy to maintain security through the tunnel, however the necessary large size of 8 or 16 octets significantly affects the size of the outer packet header. This is significant particularly where all or a part of the WAN has limited bandwidth to carry packets. If the IV were not included in the outer packet header, then some other provision would be necessary to ensure that sufficient entropy is generated to secure the inner packet.

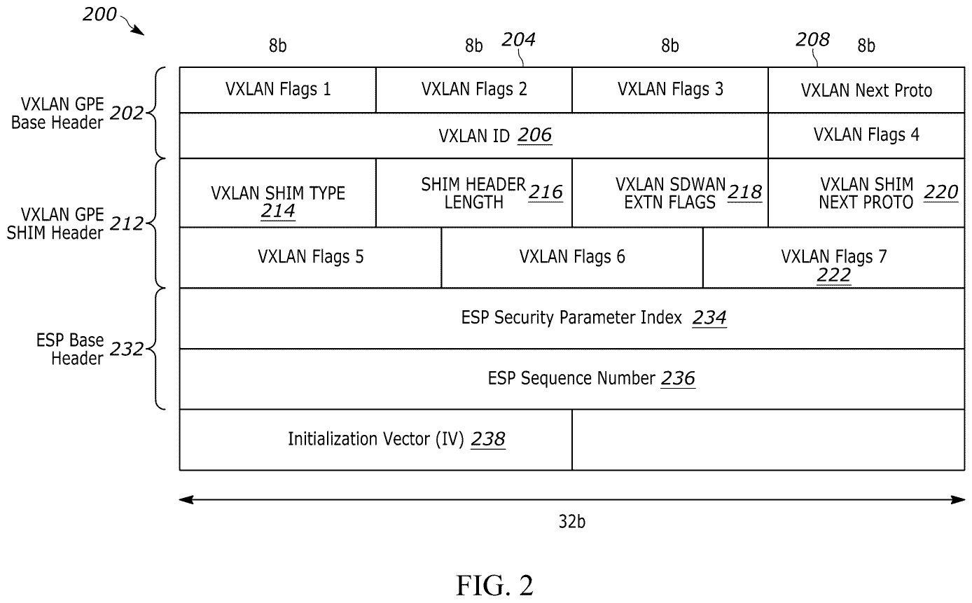

FIG. 2 is a diagram of an example of a portion of an outer packet header 200 that may be used in a secure tunnel, e.g., in an SDWAN overlay environment. The data in the header is sent in the clear to allow the outer packet to be routed through public networks and diverse private networks. The outer packet header 200 is 32 bits long on the horizontal axis and 7 rows on the vertical axis. A Virtual Extension Local Area Network (VXLAN) Generic Protocol Extension (VPE) Base Header 202 has two rows that include fields to carry VXLAN flags 204, a VXLAN Identification (ID) 206 and a VXLAN Next Protocol 208. A VXLAN GPE shim Header 212 has fields to carry type 214, header length 216, extension flags 218, next protocol 220, and flags 222. An ESP Base Header 232 has two rows to carry fields for a security parameter index 234 and a sequence number 236. The fields in the first six rows may have a type-length-value (TLV) structure. Other structures may be used to suit different protocols and conventions. A final row carries the IV 238. As shown, the IV 238 consumes half of the 32 bits of the row, however, the IV 238 may be larger to suit different implementations. The outer packet header 200 is of a type that is sent with each packet. This allows the IV 238 to be changed by the sending hub at any time.

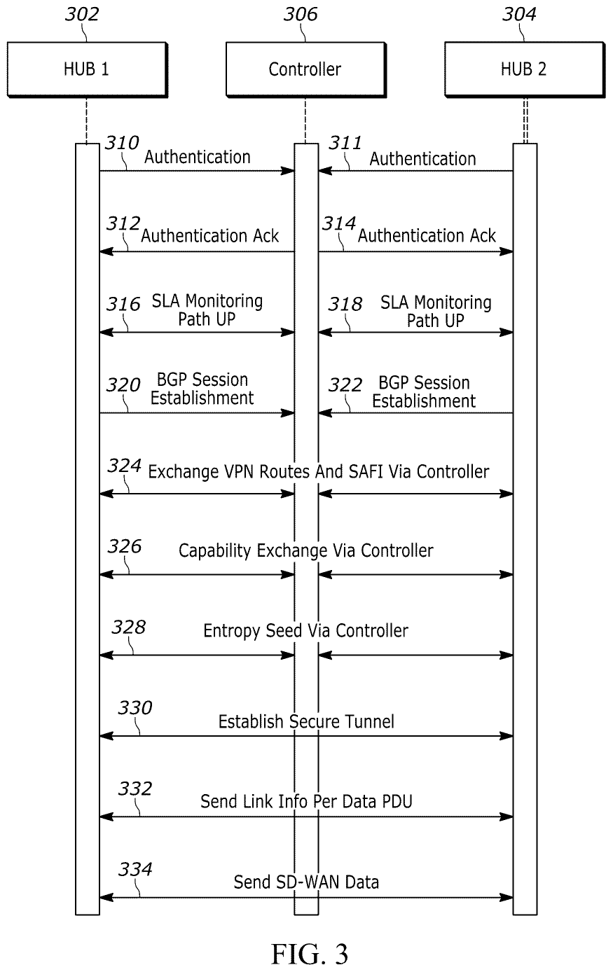

FIG. 3 is a message sequence diagram of establishing an SDWAN overlay and capabilities for local generation of an Initialization Vector (IV) through a controller using the control plane. Information may be collected to generate and maintain system information in Multi-Protocol Border Gateway Protocol (MP-BGP), such as protocols, security, encryption, and routing information. This information may be sent in data Protocol Data Units (PDU) in, for example, Protocol Extension packets of various kinds, including Generic Protocol Extension (GPE) as shown e.g., in FIG. 2. A capability exchange allows the controller to send and receive site-lists and other information OOB through the control plane. It may also allow SDWAN flow and other auxiliary information to be exchanged using Type, Length, Values (TLV), Address Family Indicators (AFI), SAFI (Subsequent AFI), or other fields in MP-BGP messages.

As shown, a controller 306 is in communication through the control plane with multiple hubs including a first hub 302 and a second hub 304. The first hub 302 and the second hub 304 are acting here as edge nodes to connect disparate networks through an SDWAN. Only two hubs are shown but there may be many more. A first hub 302 sends an authentication request 310 to the controller 306 and a second hub 304 also sends an authentication request 311 to the controller 306. These requests may include key exchanges, policy exchanges, key management protocols and other information. The controller acknowledges the authentication with an acknowledgment message 312 to the first hub 302 and an acknowledgment message 314 to the second hub 304. Additional NAT (Network Address Translation) security parameters and payload configuration information may also be exchanged. Service Level Agreement (SLA) monitoring is configured as UP with a further message exchange 316 with the first hub 302 and a further message exchange 318 with the second hub 304. A BGP session may then be established through the control plane with session and connection establishment messages 320 from the first hub to the controller and session and connection establishment messages 322 from the second hub 304 to the controller. These messages are all out-of-band (OOB) messages through the control plane.

The hubs may then exchange virtual private network (VPN) routes, AFI, SAFI and other information at 324. A capability exchange may be performed at 326 via the controller 306. The capability exchange may include virtual LAN information, flow identifiers, worker thread IDs, and other information. The capability exchange may also determine whether the hubs support generating an IV locally using an entropy seed exchanged through the control plane or the secure tunnel. The hubs may not support local IV generation due to different software or firmware versions or different manufacturers that have reduced interoperability. In some cases, an administrator may disable local IV generation in some or all of the hubs under that administrator. In the event that one or the other of the two hubs do not support local IV generation, the configuration process proceeds without exchanging entropy seeds. Instead, the IV 238 will be sent in the outer packet header of each packet through the secure tunnel as shown in FIG. 2. In the event that both hubs support local IV generation, then an entropy seed is exchanged 328 via the controller initially and also updated at a time interval, e.g. an entropy reseed interval Eᵢᵥₐₗ. The two hubs then generate the IV locally and the IV 238 (shown in FIG. 2) is not included in the outer packet header of any of the outer packet headers through the secure tunnel. The capability exchange 326 may also be performed in the control plane.

A secure tunnel may be established at 330. Using the secure tunnel, entropy seeds may be exchanged at 330 and link information may be sent in respective data PDUs at 332. The data plane and secure tunnel are now established. At 334 secure data may be exchanged through the tunnel between the first hub 302 and the second hub 304. In some embodiments a TLV (Type Length Value) may be sent in one or more of the secure packet headers using BGP or other protocols, e.g., BGP private SAFI, in the control plane of the SDWAN overlay. The entropy seed may be updated through such data exchanges including using a BGP SAFI in the control plane of the SDWAN overlay.

The Initialization Vector (IV) information may be removed from the header of FIG. 2 or any other type of SDWAN outer packet header, depending on the particular implementation. Removing the IV 238 reduces the size of the wrapper, allowing for other overhead, more payload, or other uses of the system bandwidth. Instead of sending the IV 238 from the transmitter to the receiver, the receiver generates the IV locally. Provided that the transmitter and receiver are using the same entropy seeds to locally generate the IV, the encryption of the inner packet will correlate with the decryption of the same inner packet. For security, the entropy seeds may also be exchanged securely, e.g., using BGP. Reducing the overhead in a bandwidth constrained environment is easily done using spare compute at the receiver for generating the entropy seed and the IV on a per-<peer, tenant> basis.

The entropy for encryption operations and decryption operations may be generated based on exchanging entropy seeds that provide partial entropy information across the SDWAN network. In some embodiments, the partial entropy information may be exchanged for each branch and tenant combination. In this case, the branch is operating as a hub, as described above, that sends encrypted inner packets to a tenant, wherein the tenant is acting as a client that is coupled to a receiving branch or hub.

In some embodiments, the partial entropy information may be self-advertised to other peers using e.g. BGP at a selected time interval, K. The time interval may be fixed in advance or adjusted as appropriate. The partial entropy information may be described as a set of one or more entropy seeds. In an example, the set may be identified as follows: <E_en, L_en, N, L_n, E_de, L_de, g_n>. More or fewer parameters may be used as the entropy seed to suit different implementations. In some configurations, one or more parameters of the entropy seed may be fixed and not included in the exchange. In some configurations, more parameters may be sent by the encrypting hub to the decrypting hub. In some configurations, the time interval, K, or another time interval may be included with the entropy seed parameters. The entropy seed parameters may be sent in a BGP private SAFI through the control plane, or in any other protocol or packet that provides sufficient security and reliability through the public or private WAN.

In this example, the entropy seed parameters may be described as follows:
E_en: Entropy bytes for encryption;
L_en: Entropy length for encryption;
E_de: Entropy bytes for decryption;
L_de: Entropy length for decryption;
N: Nonce bytes;
L_n: Nonce length;
g_n: Generation number incremented for each change in the other values.

The advertisement interval K applies to advertisements that occur after the seeding is complete. The advertisement interval may be chosen to diminish predictability for an attacker. In some implementations, e.g., IPSec, a DH (Diffe-Hellman) KEY child Security Association (SA) advertisement may be sent. The child SA advertisement is sent at some interval, I_sa. To reduce chatter, the seeding for the IV may be done together with the DHKEY child SA advertisement and at the same interval so that I_sa is used as K.

Using a BGP private SAFI, the entropy seed may be sent as a TLV, <type, bytestream, length>. The TLV may be sent within an extension to the BGP private SAFI which carries specific information in the control plane about the SDWAN overlay. In this extension, the bytestream portion of the TLV will be opaque to all except an IPSec module. The exchange 328 of entropy seeds of FIG. 3 may be used to send the private SAFI.

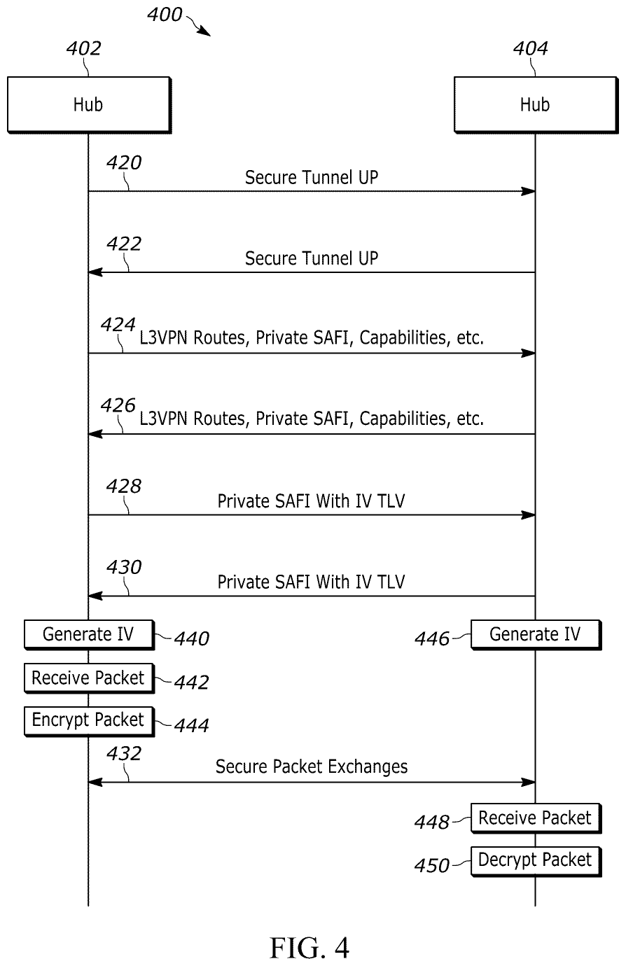

FIG. 4 is a message sequence diagram of propagating entropy seeds in an SDWAN overlay with BGP. The message sequence 400 may be combined with the messages of FIG. 3. At 410 a first hub 402 sends a message to a second hub 404 that the secure tunnel for the SDWAN is up. This message may include other information for SLA monitoring and other capabilities. The message may correspond to message 330 of FIG. 3. Corresponding to message 330, the second hub 404 at 412 may also send a message to the first hub 402 that the secure tunnel for the SDWAN is up. These messages are sent out-of-band using a secure protocol, e.g. BGP.

The first hub 402 may then send at 424 additional information about the secure tunnel, such as Layer 3 Virtual Private Network (VPN) routes, private SAFI, capabilities., etc. The second hub 404 at 426 may reply with its own Layer 3 VPN routes, private SAFI, capabilities, etc. This may all be sent using BGP as OOB messages in the control plane. As mentioned above, the IV TLV does not include the IV but the entropy seed with which to generate the IV. The first hub 402, at appropriate advertisement interval K, may then send 428 an IV TLV in a BGP private SAFI. The particular information in the bytestream of the TLV may be as mentioned above and include the entropy seed parameters, e.g., entropy bytes, entropy length, nonce bytes, and nonce length, with the generation number and the reseed interval in some implementations. The second hub 404, at appropriate advertisement interval K, may then reply 430 with a corresponding IV TLV in a BGP private SAFI. The information in the reply allows the second hub to send encrypted inner packets to the first hub 402. Alternatively, as shown in FIG. 3, the IV TLV may be exchanged before the data plane secure tunnel is established at 420.

With the configuration and exchange of the parameters of the entropy seed through the control plane, the first hub 402 and the second hub 404 have secure packet exchanges at 432 across the data plane through the secure tunnel. The first hub generates 440 the IV locally using the entropy seed, receives 442 a packet from a local client, encrypts 444 the packet using the IV and an inner packet encryption key and then sends the inner packet through the secure tunnel through secure packet exchanges 432. The second hub 404 generates 446 the IV locally using the entropy seed, receives 448 the inner packet through the secure tunnel, decrypts 450 the inner packet using the IV and a decryption key, and forwards the inner packet to the destination client as defined in the inner packet. The secure packets are inner packets for which the payload has been received from a suitable client. The inner packets are wrapped in an outer packet to enable an overlay environment to provide an SDWAN through a WAN between the first hub 402 and a second hub 404. The outer packet may have a reduced packet header that does not include the IV in each packet. Instead, the entropy seed is exchanged OOB at a suitable entropy reseed interval and the IV is not exchanged but generated locally. The first hub 402 generates the IV locally for use in encrypting transmissions and, for two-way communication, generates another IV locally, using an entropy seed from the second hub 404, for decrypting transmissions from the second hub 404.

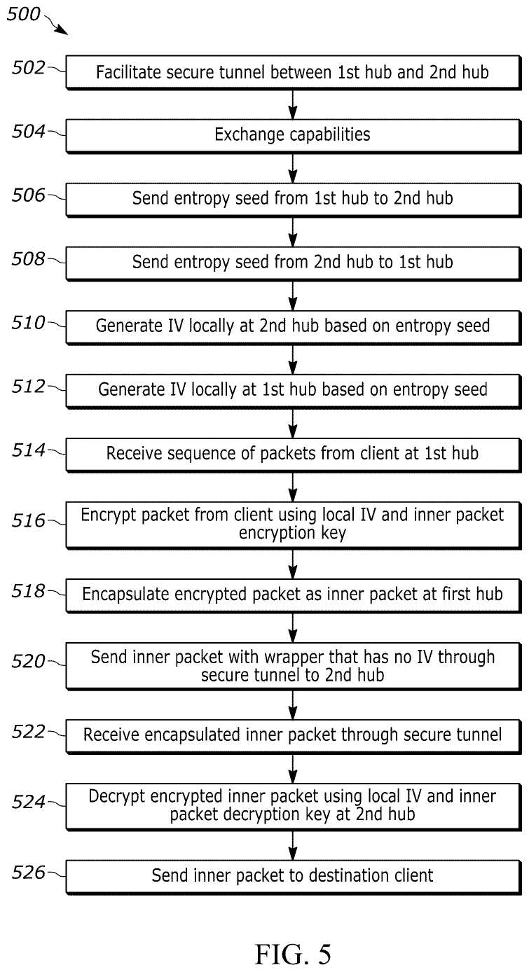

FIG. 5 is a process flow diagram of routing traffic from a first hub to a second hub through a software-defined wide area network (SDWAN) with a reduced outer packet header. The outer packet header does not include the IV. The process starts at 502 with facilitating a secure tunnel between the first hub and the second hub. The secure tunnel may include a session between the first hub and the second hub, e.g. using BGP connectivity and SLA monitoring, etc. At 504, a capabilities exchange may be performed between the first hub and the second hub before or after facilitating the secure tunnel. The capabilities exchange may be performed in the control plane with the controller or in the data plane directly between the two hubs through the secure tunnel. The capabilities exchange may include determining whether both hubs support a reduced outer packet header mode with local generation of encryption keys.

The capabilities exchange may also include choosing policies and determining compression and encryption parameters. In some examples, the first hub is exchanging capabilities with the second hub before sending the entropy seed to determine that the second hub supports generating the initialization vector based on the entropy seed. The first hub then encrypts using an initialization vector that is also supported by the second hub.

The method continues with sending an entropy seed from the first hub to the second hub at 506. At 508, an entropy seed is sent from the second hub to the first hub. The first hub is receiving the entropy seed at the first hub from the second hub. In examples, the first hub and the second hub use the same entropy seeds, and the entropy seeds are sent from either one of the hubs to the other hub. In examples, a first entropy seed is used for packets in one direction and a second entropy seed is used for packets in the opposite direction. After the exchange of entropy seeds, each hub is able to generate an initialization vector (IV) locally. At 510, the second hub generates an IV locally using the entropy seed. At 512, the first hub generates an IV locally using the entropy seed that it received from the second hub.

At 514, the first hub receives a sequence of packets from a first client at the first hub. The sequence of packets may be for one flow from one client to another client or the sequence of packets may include packets to be sent to a variety of different clients through the first hub to the second hub. At 516, the first hub encrypts a packet from the first client using the locally generated IV from operation 512 and an inner packet encryption key. In some examples, the configuration operations of facilitating a secure tunnel, exchanging capabilities, sending, and receiving entropy seeds, and generating initialization vectors may all be performed before receiving the packets. In some examples, the configuration operations may be performed as a response to receiving packets, parsing the 5-tuple of the packets, and determining a second hub through which to route the received packets. At 518, the first hub encapsulates the encrypted packet as an inner packet and at 520, the first hub sends the inner packet with a wrapper through the secure tunnel to the second hub. The wrapper does not include an initialization vector as part of the outer packet header. Instead, the second hub generates the initialization vector locally using the entropy seed sent at 506.

At 522, the second hub receives the encrypted inner packet with an outer packet wrapper through the secure tunnel. This received wrapper has no initialization vector in its outer packet header. The second hub decrypts the inner packet at 524 using the local IV generated at 510 and an inner packet decryption key. At 526 the second hub sends the inner packet to the destination client. The inner packet has its own destination IP address in its header which indicates the destination client to which the decrypted inner packet is to be sent.

Considering local IV generation in a more detailed example, there may be a function D for a Deterministic Random Bit Generator (DRBG). The function may take two forms, one for encryption Dₑₙ and another for decryption D_{de}. The DRBG may be used as the encryption and decryption function together with an operation on the data such as XOR or another suitable operation. The DRBG function is seeded using the entropy seeds discussed above. After the DRBG function has been initialized then the DRBG function may continue for encryption and decryption operations until there is a reseeding. The entropy reseed interval Eᵢᵥₐₗ may be selected based on security, bandwidth, and other parameters with consideration for the nature of the packet data flow.

The first hub and second hub may advertise entropy seed parameters through BGP sessions to each other and to other hubs. In an example, to support the DRBG functions, the advertisements, identified as Initialization Vector Parameters (IVP) for hub a and hub b may include particular entropy seed parameters:

$${IVP}_{a} ( 〈 {E}_{ena} , {L}_{ena} , {E}_{dea} , {L}_{dea} 〉 , {N}_{a} {L}_{na} , {g}_{n} = 1 ) \qquad Hub 1$$

$${IVP}_{a} ( 〈 {E}_{enb} , {L}_{enab} , {E}_{deb} , {L}_{deb} 〉 , {N}_{a} {L}_{nb} , {g}_{n} = 1 ) \qquad Hub 2$$

As above, these entropy seed parameters indicate the Entropy bytes, Entropy length, Nonce bytes, Nonce length, and Generation number of the seed for the IV, where the Generation number gₙ is like a series number to track successive sets of entropy seed parameters. In some examples, while entropy and nonce information are exchanged initially when the secure tunnel is established. For subsequent reseedings, the same nonce bytes and nonce length may be used so that only the entropy bytes and entropy length is exchanged.

A seeding function, F, for the DRBG function may be operated using these entropy seed parameters, so that F (Entropy bytes, Entropy length, Nonce bytes, Nonce length, Gen), where F is a composite function such as XOR over the input.

After the advertised entropy seed parameters IVPₐ and IVP_{b} have been received at both ends, the seeding function F may be run such that:

$${D}_{e n} = F ( {IVP}_{a e n} , {IVP}_{b e n} ) , {D}_{d e} = F ( {IVP}_{b d e} , {IVP}_{b d e} ) ,$$

where D=the DRBG (Deterministic Random Bit Generator) Context for encryption and decryption, respectively. Using the seeding contained in the first hub's advertisement and the seeding contained in the second hub's advertisement, the D_en and D_de function may be operated for entropy generation and IV creation from the time the seeding is completed indefinitely. For better security or for an interruption in the packet transmission, the DRBG function may be reseeded. In some examples, there is an entropy reseed interval, e.g. Eᵢᵥₐₗ. Frequent reseeding provides better security to protect the inner packets from interception and brute force computation.

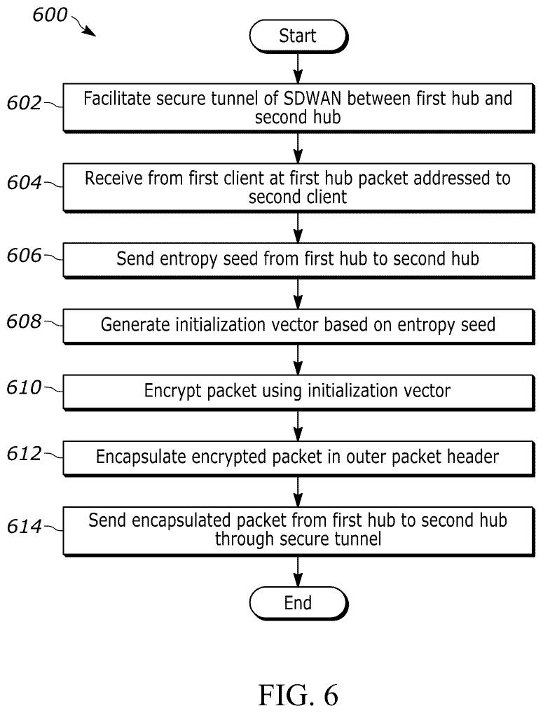

FIG. 6 is a process flow diagram from the perspective of a single hub of routing traffic from a first hub to a second hub through a software-defined wide area network (SDWAN) with a reduced outer packet header. The process 600 may be reciprocal such that both the first hub and the second hub perform this process. Alternatively, one of the two hubs may send entropy seed parameters for encapsulated packets in both directions, i.e. for an initialization vector used with encryption and for an initialization vector used with decryption at the second hub. At 602 a secure tunnel of the SDWAN is facilitated between a first hub and a second hub. At 604 entropy seed parameters are sent from the first hub to the second hub. The entropy seed parameters may be generated locally or received from a controller of an overlay network of the SDWAN. These entropy seed parameters are used at 606 in which the first hub generates an initialization vector based on the entropy seed parameters. For symmetrical encryption, at the second hub, the entropy seed parameters are similarly used to generate an initialization vector for decryption. Alternatively, for asymmetrical encryption the sent entropy seed parameters at 606 may be different from those used to generate the IV at 608.

At 608 a packet is received from a first client at the first hub, the packet addressed to a second client. At 610 the packet is encrypted at the first hub using the initialization vector. In some examples, this may be done without imposition, i.e., without imposing a header on the packet. The encryption operation may be as described above using a seeding function and DRBG or another encryption operation may be used. The specific seeding operation and the entropy seed parameters for those operations may be determined during the capabilities exchange.

At 612 the encrypted packet is encapsulated in an outer packet header. At 614 the encapsulated packet is sent from the first hub to the second hub through the secure tunnel. The first hub may send further packets to the second hub from the same client and using the same IV. Similarly, the second hub may send packets to the first hub using the same IV that is generated locally at both hubs. In examples herein, the IV is used only for packets that have the same 5-tuple. Packets received at the first hub with a different 5-tuple are sent using different entropy seeds. In addition, the entropy seeds may be updated to a next generation number at intervals, e.g., Eᵢᵥₐₗ. When the entropy seeds are updated, it may not be necessary to provide the nonce information only the entropy seeds. In some examples, the entropy length is also not updated, only the entropy seeds. This reduces the overhead compared to transmitting the full IV in the packet header of each packet.

In an example, once the DRBG has been initialized, using the IV parameters, the IV entropy for encryption may be generated using a generation function. The same function may be used for each packet encrypted on the transmit side and decrypted on the receive side.

For encryption, IV entropy bytes are generated using a generation function F_{gen}, alternately referred to as a variable “drbg_gen_entropy_bytes.” The function may be expressed as follows:

$${IV}_{e n} = {F}_{gen} ( {D}_{e n} , {OData}_{opt} , {L}_{buf} )$$

For decryption, IV entropy bytes are generated using the same generation function F_{gen}, alternately referred to as a variable “drbg_gen_entropy_bytes” using the decryption random bit D_{de}. The function may be expressed as follows:

$${IV}_{d e} = {F}_{gen} ( {D}_{d e} , IDat {a}_{opt} , {L}_{buf} )$$

Where IVₑₙ/IV_{de} is used as the IV for encryption and decryption cryptographic operations.
F_{gen} is the generation function to generate the IV entropy,
D is the DRBG function, discussed above for encryption and decryption, respectively.
ODataₒₚₜ is an Output Data sequence number, e.g. a unique packet sequence number for each packet. In some examples, the ESP sequence number may be used.
IDataₒₚₜ is a corresponding Input Data sequence number, and
L_{buf} is the output buffer length, which may be the IV length, e.g. 8 or 16 octets.

The values may be tested upon configuration and in the field to ensure that the correct entropy seeds are received and that the DRBG function is correctly initialized. In many implementations, the entropy seeds and configurations may be configured so that the entropy seeds used for generating initialization vectors for encryption and decryption are the same and result in the same initialization vectors. In other encryption configurations, this is not necessary. The necessary equality of the IV may be expressed as:

$${IV}_{d e} ≡ {IV}_{e n}$$

The entropy seeds are refreshed at intervals for increased security. For faster reseeding, a configurable parameter, e.g., a predetermined or selected entropy reseed interval Eᵢᵥₐₗ may be used. In some examples, the generation number mentioned above, and referred to as gen or G_{x,y} may be used for entropy reseed transactions. The parameter G_{x,y}, as described herein has two indices, x, y. The first, x, indicates the generation number of entropy seed in use at the hub maintaining the value, the local hub, and the second, y, indicates the generation number of entropy seed in use at the other hub, the remote or peer hub. The local hub may generate the x entropy seed while the remote hub generates the y entropy seed. The local hub may also be the hub that generated the seed while the remote hub is the hub to which the seed has been sent. The indices are a mechanism to track the entropy seed status. When the indices do not match, then the hub resends the locally generated entropy seed until the remote hub acknowledges the entropy reseed. The local hub then updates the indices to match, indicating that both hubs are operating on the same generation number. While indices are described herein, any other system or methodology to track the synchronization of the entropy seeds may be used. In some examples, the nonce values are sent only once during initial secure tunnel establishment. For subsequent reseed intervals only the entropy seeds are updated.

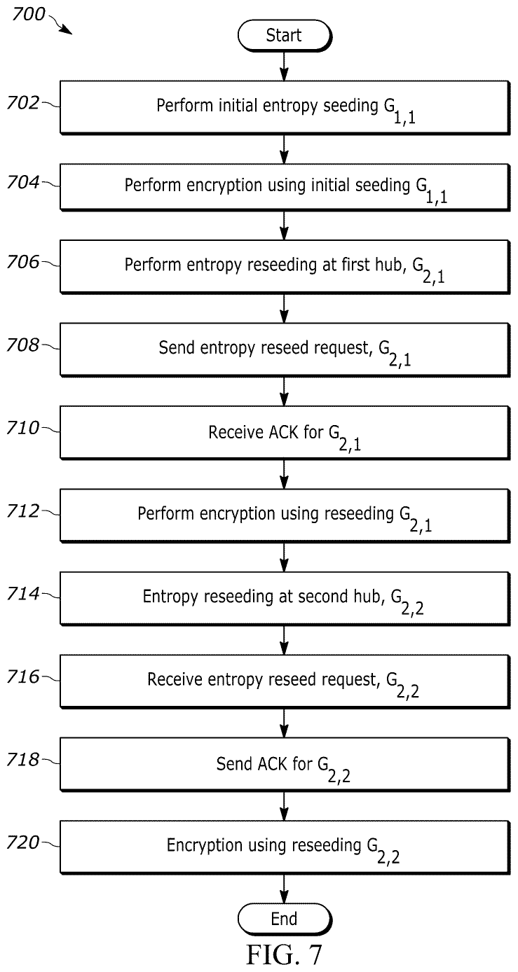

FIG. 7 is a process flow diagram of entropy reseeding from a first hub to a second hub through a software-defined wide area network (SDWAN). In an example, using the described indices, after the initial seeding 702, the DRBG contexts Dₑₙ, OR D_{de} is at G_{1,1} (<self-gen, peer-gen>). Here the first index is identified as the index at the hub for the generation number in use by itself, self-gen. The second index identifies the generation number in use by a peer to itself, peer-gen. Encryption is performed using the initial seeding G_{1,1} at 704. The first hub generates a first initialization vector using the first generation first partial entropy seed, as indicated by the first index, and the first generation second partial entropy seed, as indicated by the second index. The first hub then encrypts a first packet using the first initialization vector and send the encrypted first packet to the second hub through the secure tunnel. The second hub similarly encrypts packets using the same first initialization vector and sends encrypted packets to the first hub thought the secure tunnel. The first hub and the second hub also use the first initialization vector in decrypting received packets received from the other hub through the secure tunnel.

On reseeding, the first hub has incremented itself to a second-generation entropy seed. In this example the generation number is incremented from 1 to 2. Upon entropy reseeding at the first hub 706, a new DRBG context is created which is identified with G_{2,1}. However, the DRBG context with G_{1,1} is still used by the first hub at 706, to encrypt any transmitted packets until after the second hub receives and acknowledges the transition to G_{2,1}. After the second hub has incremented itself to a second-generation entropy seed and the first hub is updated to the second hub's entropy reseed then the generation numbers are synchronized at 720 for the two hubs. While this state is referred to herein as an initial or generation 1 state, it is only initial with respect to being before the next state. The processes and messages described may apply to a first state or a much later state. The generation indices need not be sequential from 1 but may take any sequence and may be defined with a modulus such that the sequence starts over again after reaching a value, such as 4, 8 or 16.

In order to update the second hub, at 708, the first hub sends an entropy reseed request for G_{2,1}. The first hub sends a second generation first partial entropy seed, as indicated by the first index updated to 2, from the first hub to the second hub. This may include sending the IV in a TLV with the reseeded entropy for G₂ from the first hub to the second hub in the control plane through a controller. The first hub may also send an out-of-band Packet Data Unit (PDU) with reseeded entropy G_{2,1}. The OOB PDU may be sent through the control plane or through the secure tunnel to the second hub using Internet Control Message Protocol (ICMP) with a unique ICMP type. The OOB PDU may specify <branch, tenant, G_{2,1}>. G_{2,1} indicates to the second hub that the first hub is updated but that the first hub does not know that the second hub has been updated.

The second hub may respond with an acknowledgment (ACK) for G_{2,1}. The second hub acknowledges the out-of-band (OOB) PDU from the first hub. In an example, the second hub sends the ACK in an out-of-band PDU in reply specifying <branch, tenant, G_{2,1}>. G_{2,1} indicates to the first hub that the second hub is updated. The first hub receives the ACK for G_{2,1} at 710. This ACK is an acknowledgment of the second generation first partial entropy seed from the second hub received at the first hub. With the second hub acknowledgment, the first hub may perform encryption using the reseeding G_{2,1} at 712. The first hub generates a second initialization vector at the first hub based on the second generation first partial entropy seed and the first generation second partial entropy seed for use in the encryption. The second hub also generates the second initialization vector based on the second generation first partial entropy seed and the first generation partial entropy seed at the second hub. The second hub may also perform encryption using the reseeding G_{2,1} and send these encrypted packets to the first hub. The first and second hubs will apply this reseeding also to decrypting received packets from the other through the secure tunnel.

If the second branch has already received the new (gen 2) entropy seed information, then the second hub will create DRBG contexts, Dₑₙ, D_{de} with G_{2,2} for itself, at 714. The generation indices indicate that the generation state is updated locally so the generation numbers are normalized. In this encryption configuration, the first hub encrypts and sends packets using the locally generated second initialization vector. The second hub receives and decrypts the packets using its locally generated second initialization vector. The process may be the same in reverse, substituting the first hub for the second hub and vice versa. In another implementation, the same initialization vector, entropy seeds, and generation indices are used for traffic in both directions.

After the second hub has created the new DRBG contexts, at 714, it sends the new reseeding G_{2,2} in an OOB PDU. In an example, the second hub sends the OOB PDU specifying <branch, tenant, G_{2,2}>. G_{2,2} indicates to the first hub hat the second hub is updated. After the first hub receives this entropy reseed request at 716, then it may send an ACK for G_{2,2}. The two hubs may each locally generate a third initialization vector based on the second generation first partial entropy seed and the second generation second partial entropy seed, as indicated by the first index of 2 and the second index of 2, and operate using the second generation entropy reseed, with indices 2, 2, at 720. A timer may be set for the next entropy reseed interval. The indices may be configured as modulo 4 or 8 to reduce the data required for the indices. If no reseed reply is received, then the first hub may send the entropy reseed request again.

Before the out-of-band PDU from the first hub is acknowledged by the second hub, both hubs continue using the older gen entropy seed from before the entropy reseed. The first hub may repeat sending the out-of-band PDU at some retry interval, R. The particular value for the retry interval may be selected based on the configuration of the network, the desired security, and the traffic. While the initial seeding requires the entropy seed, entropy length, nonce bytes, and nonce length, for any reseeding, in some examples, the nonce information may be reused. Only the entropy bytes and entropy length are required.

ICMP is built on the Internet Protocol (IP) layer, like Transmission Control Protocol (TCP) and User Datagram Protocol (UDP). Each ICMP message has a message type and a message code field, typically to manage errors or provide informational reporting for IP networks. ICMP messages may be used as described herein with a unique type and code for seeding and reseeding the IV, as shown in FIG. 7, however other types of messages or protocols may be used instead. In one example, a custom ICMP packet for new seed generation as shown in FIG. 7 may be structured as shown in the table. In the table, the ICMP Type and Code are for new seed generation and the actual seeds are carried in the New Seed Generation G_x,y field.

TABLE

| | |
|---|---|
| ICMP Type ICMP Code | Checksum |
| Additional Headers | |
| Flags (REQ/ACK) | New Seed Generation G_xy |

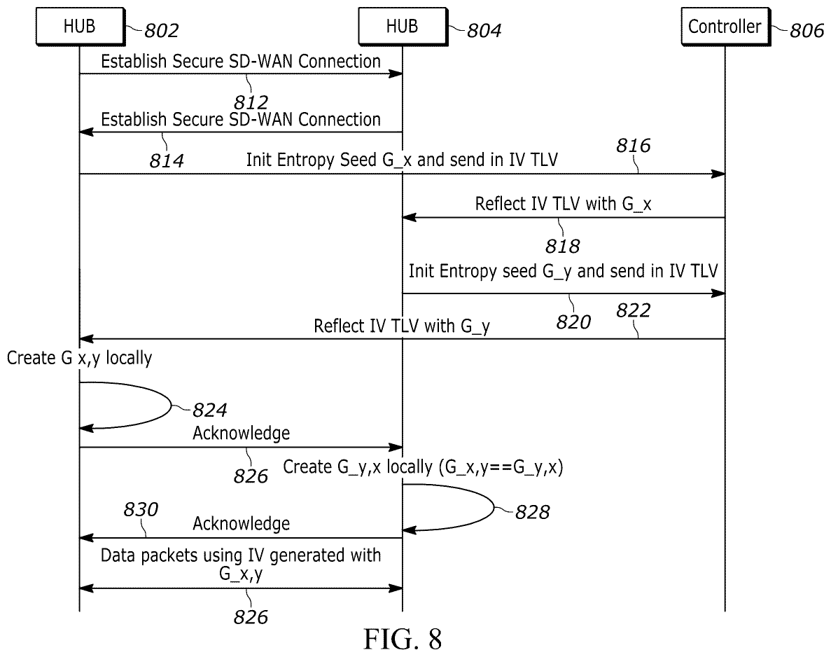

FIG. 8 is a message sequence diagram of establishing an initialization vector using entropy seeds sent through a controller in an SDWAN overlay. The message sequence provides additional details that may be used in the message sequences of FIGS. 3 and 4. The sequences are for a first hub 802, a second hub 804, and a controller 806. At 812, the first hub 802 sends messages to the second hub 804 to establish a secure SD-WAN connection. This connection may be a secure tunnel in the data plane using OOB communication through ICMP or another suitable communications protocol. At 814, the second hub 804 replies to establish a secure SD-WAN connection to the first hub 802. With the secure connection established, the first hub 802 and the second hub may communicate securely through the SD-WAN and control and data messages may be exchanged accordingly. As described above, a variety of different capabilities, configuration, routing, and status messages may be exchanged through the secure tunnel.

For secure communications between the first hub 802 and the second hub 804 using an initialization vector (IV) through the secure tunnel, the first hub at 816, initializes entropy seed G_x and sends it in an IV TLV through the control plane to the controller 806. The controller 806 reflects the IV TLV with the entropy seed G_x from the controller 806 to the second hub. After, and in response to receiving the IV TLV reflected from the controller 806 at 818, the second hub 804 initializes an entropy seed G_y and sends it in an IV TLV through the control plane to the controller 806. At 822, the controller 806 reflects the IV TLV with the entropy seed G_y from the controller 806 to the first hub 802. As a result of the message exchange, both hubs now have G_x and G_y, which together is expressed above as G_{x,y} and are able to generate an IV locally using these entropy seeds. For the initial or first set of entropy seeds, this may be identified as G_{1,1}, however any other suitable designator may be used.

At 824, the first hub 802 creates G_{x,y}, e.g., G_{1,1}, locally and generates an IV as described above. Before or after generating the IV locally, the first hub acknowledges the reflected IV TLV with the entropy seed G_y from the from the controller. At 828, the second hub 804 creates Gy,x locally and generates the same IV. The second hub also acknowledges the reflected IV TLV from the controller to the first hub at 830.

Both hubs are now configured with the same IV and are ready to communicate client and tenant packets securely at 832 using the shared IV and any other security encryption parameters through the secure tunnel of the SD-WAN. In this example G_x and G_y each represent a part of the entropy seeds, Gx,y, for the generation number of the full IV for use in secure communications. The communications are indicated in FIG. 4 as secure packet exchanges 432.

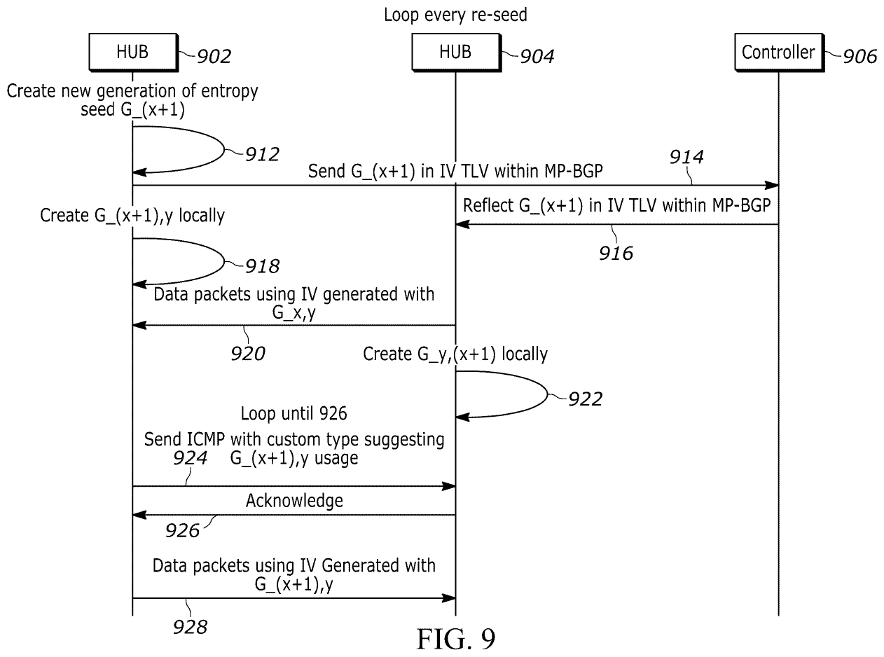

FIG. 9 is a message sequence diagram of re-seeding G_x to a different generation number for an initialization vector using entropy seeds sent through a controller in the control plane in an SDWAN overlay. These operations may correspond to operation 704 of FIG. 7. The sequences are for a first hub 902, a second hub 904, and a controller 906. In another example, the first hub 902 may be referred to as Branch 1 (B1) and the second hub 904 may be referred to as Branch 2 (B2). At 912, the first hub 902 creates a new partial entropy seed locally. The new partial entropy seed is identified as G_x+1. Stated another way when the prior first partial entropy seed is G₁, then the new first partial entropy seed may be G₂. Any suitable numbering or identification designation may be used to distinguish between different entropy seeds, including hexadecimal, alphanumeric, and other designations. At 914, the new partial entropy seed G_x+1 is sent to the controller 906 in an IV TLV using MP-BGP (Multiprotocol-Border Gateway Protocol) through the control plane. This may be sent as an OOB BGP message. At 916 the controller 906 reflects the message to the second hub 904. The controller 906 may send the message as another IV TLV within MP-BGP like the message from the first hub 902. The message includes the new partial entropy seed G_x+1 received from the first hub 902. As shown, these messages 914, 916 do not include the IV.

At 918, the first hub uses the new first partial entropy seed that it created, G_x+1, together with the second half of the entropy seed, i.e. the prior second partial entropy seed, that it already had G_y, e.g., as shown in FIG. 8, reflected by the controller at 822 from the second hub 805 through the control plane, to create a new entropy seed G_x+1,y, locally. The new entropy seed is generated locally at the first hub at 918 and allows the first hub to generate a second IV for use in sending traffic at through the data plane to the second hub 904 using the secure tunnel. However, at 920 before and after generating the new entropy seed at 918, the first hub 902 continues to send data packets using the first IV in the same way as before creating the new generation of the first partial entropy seed at 912.

The second hub, upon receiving the new partial entropy seed from the controller at 916 creates at 922 a new entropy seed G_y,x+1 for use in creating the second IV. As shown, the second IV is not passed between the two hubs only the partial entropy seed is sent through the control plane at 916 separate from any data. At 924 the first hub sends a new seed request ICMP through the data plane suggesting that the new entropy seed Gx+1, y be used for data packets through the secure tunnel. After the second hub has received the new seed request ICMP and after it has created the new entropy seed at 920, the second hub sends an acknowledgment at 926. The first hub 902 may repeat sending the ICMP with a custom type suggesting use of the new seed at 924 until it receives the acknowledgement at 926. Data packets may also be sent from the first hub and from the second hub using the first IV as at 920 until the first hub receives the acknowledgment at 926.

After receiving the acknowledgment at 926, the first hub 902 sends data packets using the second IV generated with the new seed G_x+1,y. The second hub 904 receives and decrypts these packets using the second IV that it generates locally using the new seed G_y,x+1. After the acknowledgment at 926 the second hub 904 also sends packets suing the second IV to the first hub 902. As mentioned, before sending and receiving the acknowledgment at 924 from the second hub 904, the first hub 902 and the second hub 904 may still exchange traffic using the prior entropy seed generation number, G_x,y.

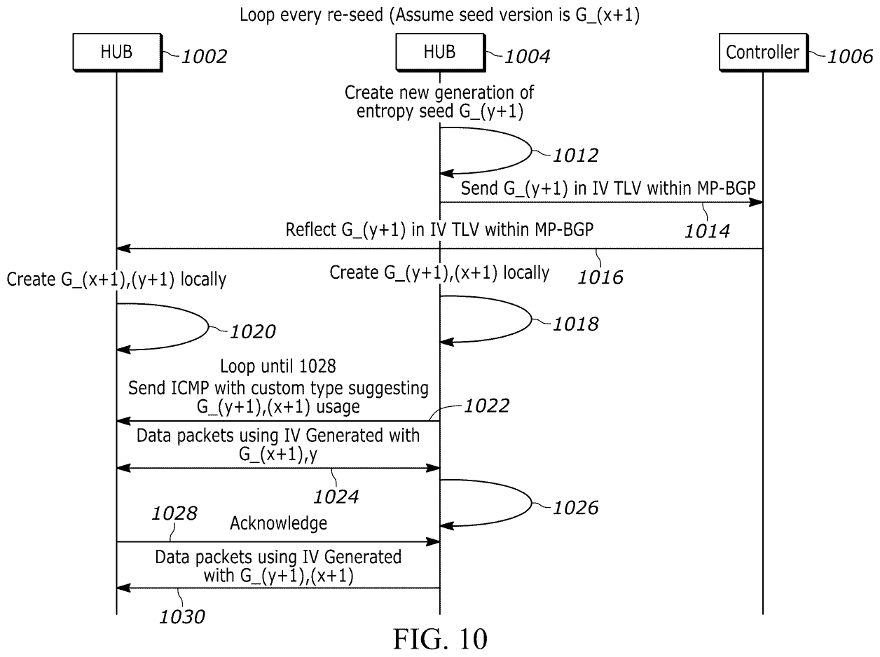

FIG. 10 is a message sequence diagram of re-seeding G_y to a different generation number for an initialization vector using entropy seeds sent through a controller in an SDWAN overlay. These operations may correspond to operation 710 of FIG. 7. The sequences are for a first hub 1002, a second hub 1004, and a controller 1006. At 1012, the second hub 1004 creates a new partial entropy seed locally. The new partial entropy seed is identified as G_y+1 or when the prior partial entropy seed is G₁, then the new partial entropy seed may be G₂. At 1014, the new partial entropy seed G_y+1 is sent to the controller 1006 in an IV TLV using MP-BGP through the control plane. At 1016 the controller 1006 reflects the message to the first hub 1002. From the controller 1006, this comes from another IV TLV within MP-BGP in a way that is like the message from the second hub. The message includes the new partial entropy seed G_y+1 received from the second hub 1004.

At the 1018, the second hub 1004 uses the new partial entropy seed that it created, G_y+1, together with the second half of the entropy seed that it received from the first hub G_x+1, e.g., from the controller at 916, to create a new entropy seed G_y+1,x+1. The new entropy seed is generated locally at the second hub 1004 and allows for a new, or third, IV for use in sending traffic through the data plane to the first hub 1002 using the secure tunnel. The first hub, upon receiving the new partial entropy seed from the controller at 1016 creates at 1020 a new entropy seed G_x+1,y+1 for use in creating the third IV. As shown, the third IV is not passed between the two hubs only the partial entropy seed is sent through the control plane separate from any data.

At 1022 the second hub 1004 sends a new seed request ICMP through the data plane to the first hub 1002 suggesting that the new entropy seed Gy+1,x+1 be used for data packets through the secure tunnel. After the first hub 1002 has created the new entropy seed at 1020, and before or after the first hub 1002 has received the new seed request ICMP at 1022, the first hub 1002 sends an acknowledgment at 1028 to the second hub 1004. Before sending and receiving the acknowledgment at 1028, the first hub and the second hub send data packets using the second IV generated locally at each hub using the prior entropy seed G_x+1,y, also referred to as G_{2,1}. After receiving the acknowledgment at 1028, the second hub 1004 sends data packets at 1030 using the third IV generated with the new seed G_y+1,x+1. The first hub 1002 receives and decrypts these packets using the third IV that it generates locally using the new seed G_x+1,y+1, also referred to as G_{2,2}. The first hub 1002 and the second hub 1004 now exchange traffic using the updated or re-seeded IV based on the Gx+1,y+1 or in this example G_{2,2}.

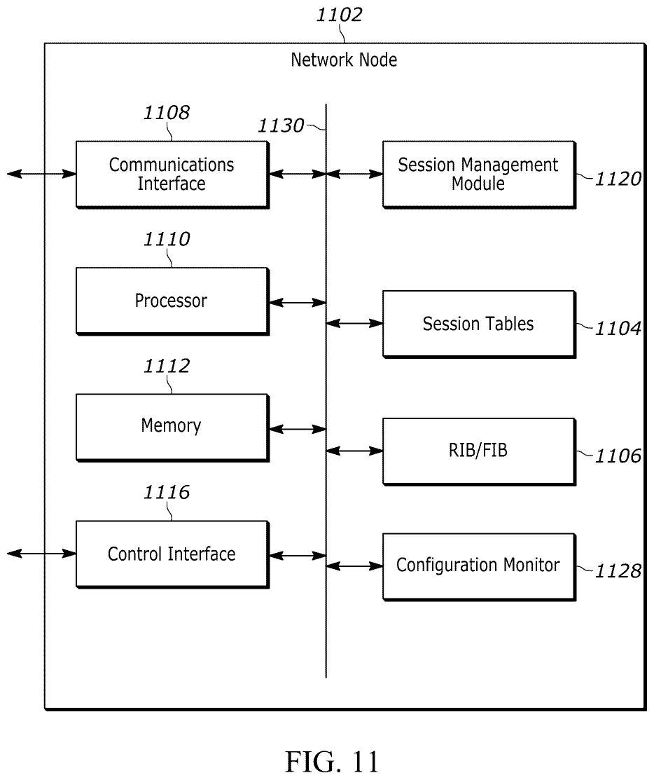

FIG. 11 is a block diagram of an apparatus, such as a network node 1102, including a hub, as described above, that communicates as a client, hub, branch, gateway, or server as described herein. The node may be a gateway, a source branch, a destination branch, an edge node, a hub, or another network node according to embodiments herein. The node includes a communications interface 1108, a processor 1110, and a memory 1112 connected together through a bus 1130. The processor 1110 may include a multifunction processor and/or an application-specific processor. The memory 1112 within the node may include, volatile and non-volatile memory for example, a non-transitory storage medium such as read only memory (ROM), flash memory, Random Access Memory (RAM), and a large capacity permanent storage device such as a hard disk drive.

The communications interface 1108 enables data communications with encryption parameters, authentication, secure tunnels, SLA metrics, route exchange, capability exchange, session establishment, etc., via local and wide area connections using one or more different protocols including Ethernet, IPsec, TLS, DTLS, Multiprotocol Border Gateway Protocol (MP-BGP), VXLAN, Multi-Protocol Label Switching (MPLS), etc. The node 1102 executes computer readable instructions stored in the storage medium of the memory 1112 to implement various tasks as described herein.

The node 1102 further includes a routing table manager with a routing information base/forwarding information base (RIB/FIB) 1106 and various other traffic caches (e.g., application cache, domain application cache, client route cache, and application route cache) to store mapping information and other traffic communication data coupled to the bus 1130. The computer in the form of the node 1102 executes computer readable instructions stored in the storage medium to implement various tasks as described above.

A control interface 1116 may be provided for node management and configuration purposes as an interface to a computer monitor or flat panel display but may include any output device. In addition, the control interface 1116 may include an interface to a computer keyboard and/or pointing device such as a computer mouse, computer track pad, touch screen, etc., that allows a user to provide inputs and receive outputs including a GUI (graphical user interface). A GUI can be responsive to user inputs and typically displays images and data. The control interface 1116 can be provided as a web page served via a communication to a remote device for display to a user and for receiving inputs from the user. Additionally, each of the modules may be implemented through instructions stored on a non-transitory computer-readable storage medium. The computer-readable instructions, e.g., program instructions, are executed on a physical processor of a computing system that supports the node to cause the computer to perform the operations described herein, among others.

The node 1102 includes a configuration monitor 1128 to monitor policy input including secure tunnel protocols, capabilities, encryption generation indices, encryption parameters, network interface state updates, and remote monitor updates, among others. The configuration monitor 1128 generates alerts or interrupts and updates backup status when there are changes to any of the monitored network node states, and configurations. The configuration monitor 1128 may also maintain a routing information base/forwarding information base (RIB/FIB) 1106.

The node further includes session tables 1104 and a session management module (SMM) 1120 to monitor any sessions that are established by the node or with the node through a secure tunnel, VPN, or other connection. The session tables may include session object states, flow identifiers, and other values. The session tables may be updated in response to error messages, flow identifiers from other hubs, and the start or end of a sequence of packets using the same 5-tuple. In embodiments, the session management module includes a secure tunnel or VPN client. Another session management module may be coupled to web clients that are operated by the processor 1110.

The embodiments disclosed herein can be implemented through at least one software program running on at least one hardware device and performing network communication functions to connect through secure tunnels and with remote servers.

It is understood that the scope of the protection for systems and methods disclosed herein is extended to such a program and in addition to a computer readable storage medium having a message therein, to such a computer readable storage medium containing program code means for implementation of one or more steps of the method, when the program runs on a server or mobile device or any suitable programmable device.

Although the operations of the method(s) herein are shown and described in a particular order, the order of the operations of each method may be altered so that certain operations may be performed in an inverse order or so that certain operations may be performed, at least in part, concurrently with other operations. In another embodiment, instructions or sub-operations of distinct operations may be implemented in an intermittent and/or alternating manner.

While the above-described techniques are described in a general context, those skilled in the art will recognize that the above-described techniques may be implemented in software, hardware, firmware, or any combination thereof. The above-described embodiments of the invention may also be implemented, for example, by operating a computer system to execute a sequence of machine-readable instructions. The instructions may reside in various types of computer readable media. In this respect, another aspect of the present invention concerns a programmed product, comprising computer readable media tangibly embodying a program of machine-readable instructions executable by a digital data processor to perform the method in accordance with an embodiment of the present invention.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the claims as described herein.

What is claimed is:

1. A method comprising:
generating a first initialization vector using a first generation first partial entropy seed and a first generation second partial entropy seed;
encrypting a first packet using the first initialization vector;
sending the first packet from a first hub to a second hub through a secure tunnel of a software-defined wide area network (SDWAN);
sending a second generation first partial entropy seed from the first hub to the second hub;
receiving an acknowledgment of the second generation first partial entropy seed from the second hub at the first hub;
generating a second initialization vector at the first hub based on the second generation first partial entropy seed and the first generation second partial entropy seed;
encrypting a second packet using the second initialization vector; and
sending the second packet from the first hub to the second hub through the secure tunnel.

2. The method of claim 1, wherein sending the first packet comprises sending the first packet through a data plane and wherein sending the second generation first partial entropy seed comprises sending the second generation first partial entropy seed through a control plane.

3. The method of claim 2, wherein sending the first partial entropy seed comprises sending the first partial entropy seed through a controller of the SDWAN.

4. The method of claim 1, further comprising encrypting subsequent packets using the first initialization vector and sending the subsequent packets through the secure tunnel until after receiving the acknowledgment.

5. The method of claim 1, further comprising:
receiving a second generation second partial entropy seed from the second hub at the first hub;
sending an acknowledgment of the second generation second partial entropy seed to the second hub from the first hub;
generating a third initialization vector at the first hub based on the second generation first partial entropy seed and the second generation second partial entropy seed;
encrypting a third packet using the third initialization vector; and
sending the third packet from the first hub to the second hub through the secure tunnel.

6. The method of claim 1, wherein sending the first partial entropy seed comprises sending entropy seed parameters.

7. The method of claim 6, wherein sending the entropy seed parameters comprises sending encryption entropy bytes and an encryption entropy length and decryption entropy bytes and a decryption entropy length for decryption.

8. The method of claim 7, wherein sending the entropy seed parameters further comprises sending nonce bytes and a nonce length.

9. The method of claim 1, wherein sending the first partial entropy seed comprises sending a generation number to indicate a generation of the first partial entropy seed of the first hub and the second hub, the method further comprising receiving a generation of the first partial entropy seed from the second hub.

10. The method of claim 9, wherein the generation from the second hub indicates an initialization vector used for decryption by the second hub.

11. The method of claim 9, wherein generating the initialization vector comprises generating the initialization vector based on the first partial entropy seed having the generation received from the second hub.

12. The method of claim 1, wherein sending the first partial entropy seed comprises sending the first partial entropy seed using a border gateway protocol.

13. The method of claim 12, wherein using the border gateway protocol comprises sending a type, length, value protocol data unit within the border gateway protocol.

14. The method of claim 12, wherein sending the entropy seed parameters comprises sending the entropy seed parameters in an out-of-band message.

15. The method of claim 1, wherein encapsulating the encrypted packet comprises generating the outer packet header without the initialization vector.

16. The method of claim 1, wherein the outer packet header includes an encapsulating security payload without the initialization vector.

17. The method of claim 1, further comprising exchanging capabilities with the second hub before sending the first partial entropy seed to determine that the second hub supports generating the initialization vector based on the entropy seed.

18. A network node comprising:
a processor; and
a storage medium having instructions stored thereon to cause the network node to perform operations comprising:
generating a first initialization vector using a first generation first partial entropy seed and a first generation second partial entropy seed;
encrypting a first packet using the first initialization vector;
sending the first packet from a first hub to a second hub through a secure tunnel of a software-defined wide area network (SDWAN);
sending a second generation first partial entropy seed from the first hub to the second hub;
receiving an acknowledgment of the second generation first partial entropy seed from the second hub at the first hub;
generating a second initialization vector at the first hub based on the second generation first partial entropy seed and the first generation second partial entropy seed;
encrypting a second packet using the second initialization vector; and
sending the second packet from the first hub to the second hub through the secure tunnel.

19. A network node comprising:
a session management module configured to facilitate a secure tunnel of a software-defined wide area network (SDWAN) between a first hub and a second hub;
a processor configured to generate a first initialization vector using a first generation first partial entropy seed and a first generation second partial entropy seed and to encrypt a first packet using the first initialization vector; and
a communications interface configured to send the first packet from the first hub to the second hub through a secure tunnel, to send a second generation first partial entropy seed from the first hub to the second hub, and to receive an acknowledgment of the second generation first partial entropy seed from the second hub at the first hub;
the processor further configured to generate a second initialization vector at the first hub based on the second generation first partial entropy seed and the first generation second partial entropy seed and to encrypt a second packet using the second initialization vector;
the communications interface further configured to send the second packet from the first hub to the second hub through the secure tunnel.

20. The network node of claim 19, wherein the communications interface is to send the first partial entropy seed through a controller of the SDWAN.
